(19) United States
(12) Patent Application Publication
(10) Pub. No.: US 2012/0105818 A1
(43) Pub. Date: May 3, 2012

(54) LITHOGRAPHIC APPARATUS AND METHOD

(75) Inventors: Jan Bernard Plechelmus Van Schoot, Eindhoven (NL); Gosse Charles De Vries, Veldhoven (NL)

(73) Assignee: ASML Netherlands B.V., Veldhoven, NL-5504 DR (NL)

(21) Appl. No.: 13/378,913

(22) PCT Filed: Jun. 7, 2010
(86) PCT No.: PCT/EP10/57916

§ 371 Date: Dec. 16, 2011

Related U.S. Application Data
(60) Provisional application No. 61/187,829, filed on Jun. 17, 2009.

(51) Int. Cl. G03B 27/54; F21V 7/04

(52) U.S. Cl. 355/67; 362/319

(57) ABSTRACT

An illumination system having a plurality of reflective elements, the reflective elements being movable between different orientations which direct radiation towards different locations in a pupil plane, thereby forming different illumination modes. Each reflective element is moveable to a first orientation in which it directs radiation to a location in an inner illumination location group, to a second orientation in which it directs radiation to a location in an intermediate illumination location group, and to a third orientation in which it directs radiation to a location in an outer illumination location group. The reflective elements are configured to be oriented to direct equal amounts of radiation towards the inner, intermediate and outer illumination location groups, and are configured to be oriented such that they can direct substantially no radiation into the outer illumination location group and direct substantially equal amounts of radiation towards the inner and intermediate illumination location groups.

### CROSS-REFERENCE TO RELATED APPLICATIONS

This application claims the benefit of U.S. provisional application 61/187,829 which was filed on 17 Jun. 2009, and which is incorporated herein in its entirety by reference.

### FIELD

The present invention relates to a lithographic apparatus and method.

### BACKGROUND

A lithographic apparatus is a machine that applies a desired pattern onto a target portion of a substrate. Lithographic apparatus can be used, for example, in the manufacture of integrated circuits (ICs). In that circumstance, a patterning device, which is alternatively referred to as a mask or a reticle, may be used to generate a circuit pattern corresponding to an individual layer of the IC. This pattern can be transferred onto a target portion (e.g. comprising part of a die, one die, or several dies) on a substrate (e.g. a silicon wafer) Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through the beam in a given direction (the “scanning”-direction) while synchronously scanning the substrate parallel or anti-parallel to this direction.

A lithographic apparatus generally includes an illumination system. The illumination system receives radiation from a source, for example a laser, and provides a radiation beam (sometimes referred to as a “projection” beam) which is incident upon a patterning device. The radiation beam is patterned by the patterning device, and is then projected by a projection system onto a substrate.

It is known in the art of lithography that an image of the patterning device projected onto a substrate can be improved by providing the radiation beam with an appropriate illumination mode. Accordingly, an illumination system of a lithographic apparatus typically includes an intensity distribution adjustment apparatus arranged to direct, shape and control the radiation beam in the illumination system such that it has an illumination mode.

### SUMMARY

A desired illumination mode may be provided by various intensity distribution adjustment apparatuses arranged to control the illumination beam so as to achieve the desired illumination mode. For example, a zoom-axicon device (a combination of a zoom lens and an axicon) can be used to create an annular illumination mode, wherein the inner radial extent and outer radial extent (σᵢₙₙₑᵣ and σₒᵤₜₑᵣ) of the illumination mode are controllable. A zoom-axicon device generally comprises multiple refractive optical components that are independently movable. A zoom-axicon device is therefore not suitable for use with, for example, extreme ultraviolet (EUV) radiation (e.g. radiation at about 13.5 nm) because radiation at this wavelength is strongly absorbed as it passes through refractive materials.

Spatial filters may be used to create illumination modes. A spatial filter with openings corresponding to a dipole mode may be provided in a pupil plane of the illumination system in order to generate a dipole illumination mode. The spatial filter may be removed and replaced by a different spatial filter when a different illumination mode is desired. However, spatial filters block a considerable proportion of the radiation beam, thereby reducing the intensity of the radiation beam when it is incident upon the patterning device. Known EUV sources struggle to provide EUV radiation at an intensity which is sufficient to allow a lithographic apparatus to operate efficiently. Therefore, it is not desirable to block a considerable portion of the radiation beam when forming the illumination mode.

It is desirable, for example, to provide a lithographic apparatus which overcomes or mitigates one or more shortcomings described herein or elsewhere.

According to an aspect, there is provided an illumination system having a plurality of reflective elements, the reflective elements being movable between different orientations which direct radiation towards different locations in a pupil plane, thereby forming different illumination modes;

each reflective element being moveable to a first orientation in which it directs radiation to a location in an inner illumination location group, to a second orientation in which it directs radiation to a location in an intermediate illumination location group, and to a third orientation in which it directs radiation to a location in an outer illumination location group;

wherein the reflective elements are configured to be oriented such that they can direct equal amounts of radiation towards the inner, intermediate and outer illumination location groups, and are configured to be oriented such that they can direct substantially no radiation into the outer illumination location group and direct substantially equal amounts of radiation towards the inner and intermediate illumination location groups.

According to an aspect, there is provided a method of switching between illumination modes, the method comprising orienting a plurality of reflective elements such that they direct equal amounts of radiation towards inner, intermediate and outer illumination location groups in a pupil plane, and then subsequently orienting the plurality of reflective elements such that they direct substantially no radiation towards the outer illumination location group and direct substantially equal amounts of radiation towards the inner and intermediate illumination location groups.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 schematically depicts a lithographic apparatus according to an embodiment of the invention;

FIG. 2 schematically depicts parts of the lithographic apparatus of FIG. 1 in more detail;

FIG. 3 illustrates operation of moveable reflective elements of an illumination system of the lithographic apparatus;

FIG. 4 illustrates an effect of movement of a primary reflective element of a first reflective component of the illumination system of the lithographic apparatus;

FIGS. 5a and 5b illustrate operation of moveable reflective elements of an illumination system of the lithographic apparatus, and a resulting y-dipole illumination mode;

FIGS. 6a and 6b illustrate operation of moveable reflective elements of an illumination system of the lithographic apparatus, and a resulting x-dipole illumination mode;

FIG. 7 depicts a first quadrant of a pupil plane;

FIGS. 8a-e depict five illumination modes obtainable using an embodiment of the invention;

FIG. 9 depicts a mounting for a reflective element;

FIG. 10 depicts a first quadrant of a pupil plane in an embodiment of the invention;

FIGS. 11a-g depict seven illumination modes obtainable using an embodiment of the invention;

FIG. 12 depicts a first quadrant of a pupil plane in an embodiment of the invention;

FIGS. 13a-n depict fourteen illumination modes obtainable using an embodiment of the invention; and

FIG. 14 depicts an illumination mode obtainable using an embodiment of the invention.

### DETAILED DESCRIPTION

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist) or a metrology or inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The terms “radiation” and “beam” used herein encompass all types of electromagnetic radiation, including ultraviolet (UV) radiation (e.g. having a wavelength of 365, 248, 193, 157 or 126 nm) and extreme ultra-violet (EUV) radiation (e.g. having a wavelength in the range of 5-20 nm), as well as particle beams, such as ion beams or electron beams.

The term “patterning device” used herein should be broadly interpreted as referring to a device that can be used to impart a radiation beam with a pattern in its cross-section such as to create a pattern in a target portion of the substrate. It should be noted that the pattern imparted to the radiation beam may not exactly correspond to the desired pattern in the target portion of the substrate. Generally, the pattern imparted to the radiation beam will correspond to a particular functional layer in a device being created in the target portion, such as an integrated circuit.

A patterning device may be transmissive or reflective. Typically, in an EUV lithographic apparatus, the patterning device is reflective. Examples of patterning device include masks (transmissive), programmable mirror arrays (reflective), and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. In this manner, the reflected beam is patterned.

A support structure holds the patterning device. It holds the patterning device in a way depending on the orientation of the patterning device, the design of the lithographic apparatus, and other conditions, such as for example whether or not the patterning device is held in a vacuum environment. The support structure can use mechanical clamping, vacuum, or other clamping techniques, for example electrostatic clamping under vacuum conditions. The support structure may be a frame or a table, for example, which may be fixed or movable as required and which may ensure that the patterning device is at a desired position, for example with respect to the projection system. Any use of the terms “reticle” or “mask” herein may be considered synonymous with the more general term “patterning device”.

The term “projection system” used herein should be broadly interpreted as encompassing various types of projection system, including refractive optical systems, reflective optical systems, and catadioptric optical systems, as appropriate for example for the exposure radiation being used, or for other factors such as the use of an immersion fluid or the use of a vacuum. Usually, in an EUV radiation lithographic apparatus the optical elements of the projection system will be reflective. Any use of the term “projection lens” herein may be considered as synonymous with the more general term “projection system”.

The illumination system can include reflective components (and/or refractive components) and optionally various other types of optical components for directing, shaping and controlling the beam of radiation.

The lithographic apparatus may be of a type having two (dual stage) or more substrate tables (and/or two or more support structures). In such “multiple stage” machines the additional tables may be used in parallel, or preparatory steps may be carried out on one or more tables while one or more other tables are being used for exposure.

The lithographic apparatus may be of a type which allows rapid switching between two or more patterning devices (or between patterns provided on a controllable patterning device), for example as described in United States patent application publication no. US 2007-0013890A1.

The lithographic apparatus may also be of a type wherein the substrate is immersed in a liquid having a relatively high refractive index, e.g. water, so as to fill a space between the final element of the projection system and the substrate Immersion liquids may also be applied to other spaces in the lithographic apparatus, for example, between the mask and the first element of the projection system Immersion techniques are well known in the art for increasing the numerical aperture of projection systems.

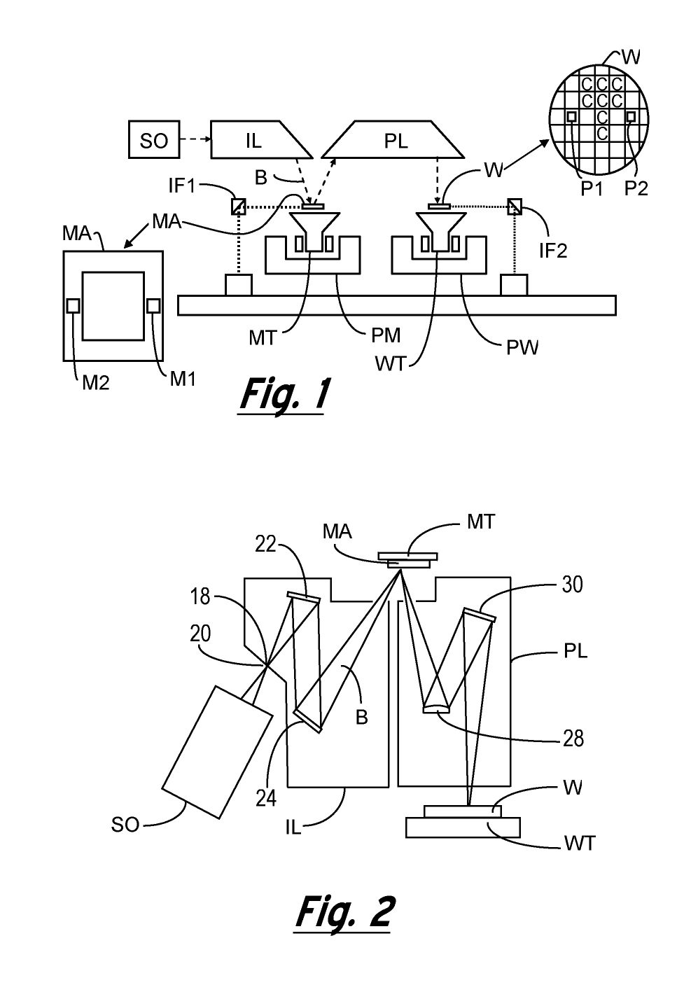

FIG. 1 schematically depicts a lithographic apparatus according to an embodiment of the invention. The apparatus comprises:

an illumination system IL arranged to condition a radiation beam B of radiation (e.g. DUV radiation or EUV radiation);

a support structure (e.g. a mask table) MT to support a patterning device (e.g. a mask) MA and connected to first positioning device PM to accurately position the patterning device with respect to item PL;

a substrate table (e.g. a wafer table) WT to hold a substrate (e.g. a resist-coated wafer) W and connected to second positioning device PW to accurately position the substrate with respect to item PL; and

a projection system (e.g. a reflective projection lens) PL configured to image a pattern imparted to the radiation beam B by patterning device MA onto a target portion C (e.g. comprising one or more dies) of the substrate W.

As depicted in FIG. 1, the lithographic apparatus of this embodiment is a reflective type apparatus (e.g. employing a reflective mask or programmable mirror array of a type referred to above). Alternatively, the apparatus may be a transmissive type apparatus (e.g. employing a transmissive mask).

The illumination system IL receives a beam of radiation B from a radiation source SO. The source and the lithographic apparatus may be separate entities, for example when the source is an excimer laser. In such cases, the source is not considered to form part of the lithographic apparatus, and the radiation beam is passed from the source SO to the illumination system IL with the aid of a beam delivery system comprising for example suitable directing mirrors and/or a beam expander. In other cases the source may be integral part of the apparatus, for example when the source is a mercury lamp. The source SO and the illumination system IL, together with the beam delivery system if required, may be referred to as a radiation system.

The illumination system IL conditions the beam of radiation so as to provide a beam of radiation with a desired uniformity and a desired illumination mode. The illumination system IL comprises an intensity distribution adjustment apparatus to adjust the spatial intensity distribution of the radiation beam in a pupil plane (for example in order to select a desired illumination mode). The illumination system may comprise various other components, such as an integrator and coupling optics.

Upon leaving the illumination system IL, the radiation beam B is incident on the patterning device (e.g. mask) MA, which is held on the support structure MT. Having traversed the patterning device MA, the radiation beam B passes through the projection system PL, which focuses the beam onto a target portion C of the substrate W. With the aid of the second positioning device PW and position sensor IF2 (e.g. an interferometric device, linear encoder or capacitive sensor), the substrate table WT can be moved accurately, e.g. so as to position different target portions C in the path of the radiation beam B. Similarly, the first positioning device PM and another position sensor IF1 can be used to accurately position the patterning device MA with respect to the path of the radiation beam B, e.g. after mechanical retrieval from a mask library, or during a scan. In general, movement of the object tables MT and WT will be realized with the aid of a long-stroke module (coarse positioning) and a short-stroke module (fine positioning), which form part of the positioning device PM and PW. However, in the case of a stepper (as opposed to a scanner) the support structure MT may be connected to a short stroke actuator only, or may be fixed. Patterning device MA and substrate W may be aligned using patterning device alignment marks M1, M2 and substrate alignment marks P1, P2. Although the substrate alignment marks as illustrated occupy dedicated target portions, they may be located in spaces between target portions (these are known as scribe-lane alignments marks). Similarly, in situations in which more than one die is provided on the patterning device MA, the patterning device alignment marks may be located between the dies.

The depicted apparatus in both FIGS. 1 and 2 can be used in the following modes:

1. In step mode, the support structure MT and the substrate table WT are kept essentially stationary, while an entire pattern imparted to the radiation beam PB is projected onto a target portion C in one go (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the support structure MT and the substrate table WT are scanned synchronously while a pattern imparted to the radiation beam PB is projected onto a target portion C (i.e. a single dynamic exposure). The velocity and direction of the substrate table WT relative to the support structure MT is determined by the (de-)magnification and image reversal characteristics of the projection system PL. In scan mode, the maximum size of the exposure field limits the width (in the non-scanning direction) of the target portion in a single dynamic exposure, whereas the length of the scanning motion determines the height (in the scanning direction) of the target portion.

3. In another mode, the support structure MT is kept essentially stationary holding a programmable patterning device, and the substrate table WT is moved or scanned while a pattern imparted to the radiation beam PB is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations of the above described modes of use, or entirely different modes of use, may also be employed.

As mentioned above, the illumination system IL comprises an intensity distribution adjustment apparatus. The intensity distribution adjustment apparatus is arranged to adjust the spatial intensity distribution of the radiation beam at a pupil plane in the illumination system, in order to control the angular intensity distribution of the radiation beam incident on the patterning device. The intensity distribution adjustment apparatus may be used to select different illumination modes at the pupil plane of the illumination system. Selection of an illumination mode may, for example, depend upon a property of a pattern which is to be projected from the patterning device MA onto the substrate W.

The spatial intensity distribution of the radiation beam at the illumination system pupil plane is converted to an angular intensity distribution before the radiation beam is incident upon the patterning device (e.g. mask) MA. In other words, there is a Fourier relationship between the pupil plane of the illumination system and the patterning device MA (the patterning device is in a field plane). The pupil plane of the illumination system is a Fourier transform plane of the object plane where the patterning device MA is located, and it is conjugate to a pupil plane of the projection system.

FIG. 2 schematically shows parts of the lithographic apparatus of FIG. 1 in more detail. The source SO generates a radiation beam B which is focused to a virtual source point collection focus 18 at an entrance aperture 20 in the illumination system IL. The radiation beam B is reflected in the illumination system IL via first and second reflective components 22, 24 onto the patterning device MA held on the support structure MT. The radiation beam B is then imaged in projection system PL via first and second reflective components 28, 30 onto a substrate W held on a substrate table WT.

It will be appreciated that more or fewer elements than shown in FIG. 2 may generally be present in the source, illumination system IL and projection system PL. For instance, in some embodiments the lithographic apparatus may also comprise one or more transmissive or reflective spectral purity filters. More or less reflective component parts may be present in the lithographic apparatus.

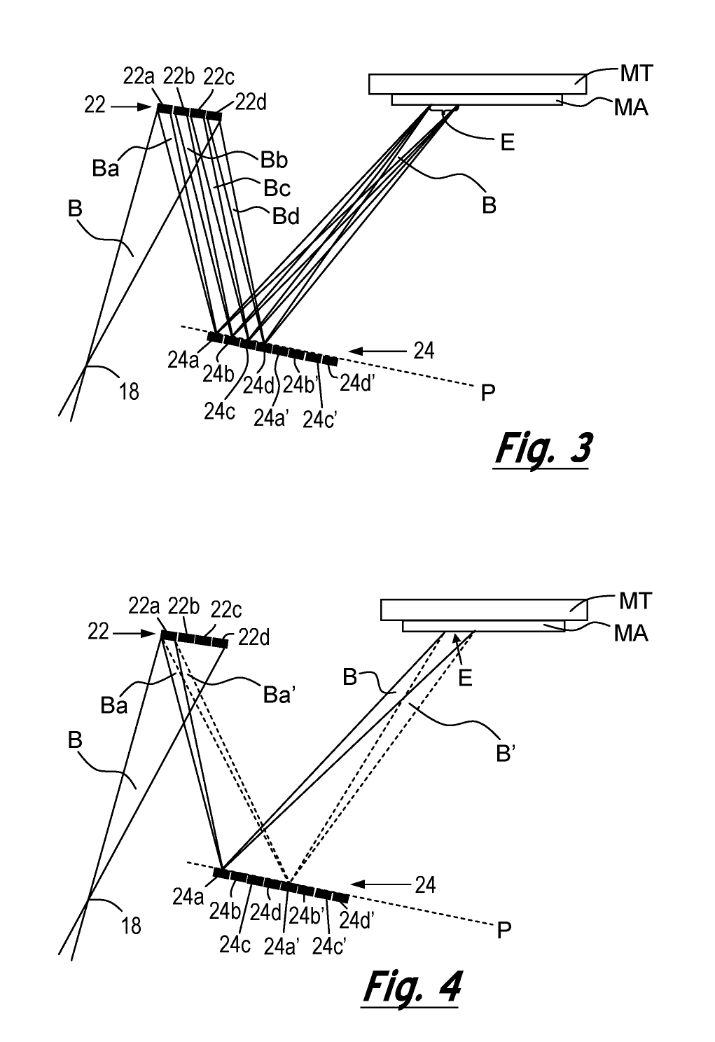

FIG. 3 schematically shows part of the lithographic apparatus, including the first and second reflective components of the illumination system in more detail. The first reflective component 22 comprises a plurality of primary reflective elements 22a-d (commonly known as field facet mirrors). The second reflective component 24 comprises a plurality of secondary reflective elements 24a-d,a′-d′ (commonly known as pupil facet mirrors). The primary reflective elements 22a-d are configured to direct (reflect) radiation towards the secondary reflective elements 24a-d,a′-d′. Although only four primary reflective elements 22a-d are shown, any number of primary reflective elements may be provided. The primary reflective elements may be arranged in a two-dimensional array (or some other two-dimensional arrangement). Although only eight secondary reflective elements 24a-d,a′-d′ are shown, any number of secondary reflective elements may be provided. The secondary reflective elements may be arranged in a two-dimensional array (or some other two-dimensional arrangement).

The primary reflective elements 22a-d have adjustable orientations, and may be used to direct radiation towards selected secondary reflective elements 24a-d,a′-d′.

The second reflective component 24 coincides with a pupil plane P of the illumination system IL. The second reflective component 24 therefore acts as a virtual radiation source which directs radiation onto the patterning device MA. A condenser mirror (not shown) may be provided between the second reflective component 24 and the patterning device MA. The condenser mirror may be a system of mirrors. The condenser mirror may be arranged to image the primary reflective elements 22a-d onto the patterning device MA.

The spatial intensity distribution of the radiation beam B at the second reflective component 24 defines the illumination mode of the radiation beam. Since the primary reflective elements 22a-d have adjustable orientations, they may be used to form different spatial intensity distributions at the pupil plane P, thereby providing different illumination modes.

In use, the radiation beam B is incident upon the primary reflective elements 22a-d of the first reflective component 22. Each primary reflective element 22a-d reflects a sub-beam of radiation towards a different secondary reflective element 24a-d,a′-d′ of the second reflective component 24. A first sub-beam Ba is directed by a first primary reflective element 22a to a first secondary reflective element 24a. Second, third and fourth sub-beams Bb-d are directed by second, third and fourth primary reflective elements 22b-d respectively to second, third and fourth secondary reflective elements 24b-d.

The sub-beams Ba-d are reflected by the secondary reflective elements 24a-d towards the patterning device MA. The sub-beams may together be considered to form a single radiation beam B which illuminates an exposure area E of the patterning device MA. The shape of the exposure area E is determined by the shape of the primary reflective elements 22a-d. The exposure area E may, for example, be a rectangle, a curved band, or some other shape.

Each primary reflective element 22a-d forms an image of the virtual source point collection focus 18 at a different secondary reflective element 24a-d,a′-d′ of the second reflective component 24. In practice, the focus 18 will not be a point, but will instead be a virtual source with a finite width (e.g., diameter), which may be, for example, 4-6 mm. Consequently, each primary reflective element 22a-d will form an image of the virtual source which has a finite width (e.g. 3-5 mm) at the secondary reflective elements 24a-d,a′-d′. The secondary reflective elements 24a-d,a′-d′ may have widths which are larger than the image widths (to avoid radiation falling between secondary reflective elements and thereby being lost). The focus 18 and images of the focus are shown as points in the Figures for ease of illustration.

The primary and secondary reflective elements have optical powers. Each primary reflective element 22a-d has a negative optical power, and forms an image of the virtual source 18 which is smaller than the virtual source. Each secondary reflective element 24a-d,a′-d′ has a positive optical power, and forms an image of the primary reflective element 22a-d which is larger than the primary reflective element. As mentioned above, the image of the primary reflective element 22a-d is the exposure area E.

The orientation of the primary reflective elements 22a-d determines the illumination mode which is formed at the pupil plane P. For example, the primary reflective elements 22a-d may be oriented such that radiation sub-beams are directed at the four innermost secondary reflective elements 24c,d,a′,b′. This would provide an illumination mode which could be considered to be a one-dimensional equivalent of a standard (disk-shaped) illumination mode. In an alternative example, the primary reflective elements 22a-d may be oriented such that radiation sub-beams are directed at two secondary reflective elements 24a-b at a left hand end of the second reflective component 24, and at two secondary reflective components 24c′-d′ at a right hand end of the second reflective component 24. This would provide an illumination mode which could be considered to be a one-dimensional equivalent of an annular illumination mode.

Each of the primary reflective elements 22a-d is configured such that it may be in one of two orientations—a first orientation and a second orientation. The first orientation is such that the primary reflective element reflects a sub-beam of radiation towards a first desired location on the second reflective component 24. The second orientation is such that the primary reflective element reflects the sub-beam of radiation towards a second desired location on the second reflective component 24. The primary reflective element is not arranged to move to a third orientation, but instead is only moveable between the first orientation and the second orientation.

FIG. 4 illustrates the movement of a primary reflective element between first and second orientations, using as an example the first primary reflective element 22a of the first reflective component 22. When the first primary reflective element 22a is in a first orientation, it directs a radiation sub-beam Ba towards a first secondary reflective element 24a of the second reflective component 24. When the first primary reflective element 22a is in a second orientation, it directs a radiation sub-beam Ba′ (shown with dotted lines) towards a second secondary reflective element 24a′ of the second reflective component 24. The first primary reflective element 22a is not arranged to move to any other orientation, and therefore is not arranged to direct the radiation sub-beam towards any other secondary reflective element 24b-d,b′-d′.

The above description refers to each primary reflective element 22a-d directing radiation sub-beams towards a secondary reflective element 24a-d,a′-d′. In any of the embodiments the secondary reflective element irradiated by a given sub-beam may be a member of a group of secondary elements all disposed within a single location on the pupil plane or on the second reflective component, the location being associated with an illumination mode. For this reason, the term “location” or “illumination location” or “illumination location group” may be used instead of secondary reflective element (the term ‘location’ being intended to encompass a single secondary reflective element or a plurality of secondary reflective elements).

Each primary reflective element 22a-d is arranged to direct a radiation sub-beam to two different locations. The first location and the second location associated with each primary reflective element 24a-d are different and unique, with respect to the locations which receive radiation sub-beams from other primary reflective elements. By configuring each primary reflective element 22a-d appropriately, radiation may be directed towards the requisite locations in the pupil plane P of second reflective component 24 so as to produce spatial intensity distributions which correspond with desired illumination modes.

Although FIGS. 3 and 4 show only four primary reflective elements 22a-d, the first reflective component 22 may comprise many more primary reflective elements. The first reflective component 22 may comprise for example up to 100, up to 200 or up to 400 primary reflective elements. The first reflective component 22 may comprise, for example, any number in the range of 100-800 primary reflective elements. The reflective elements may be mirrors. The first reflective component 22 may comprise an array of 1024 (e.g. 32×32) mirrors, or 4096 (e.g. 64×64) mirrors, or any suitable number of mirrors. The primary reflective elements may be arranged in a two-dimensional grid-like formation. The primary reflective elements may be arranged in a plane which crosses through the radiation beam.

The first reflective component 22 may comprise one or more arrays of primary reflective elements. For example, the primary reflective elements may be arranged or grouped to form a plurality of arrays, each array for example having 32×32 mirrors. In the text, the term “array” may mean a single array or a group of arrays.

The secondary reflective elements 24a-d,a′-d′ may be mounted such that the orientations of the secondary reflective elements are fixed.

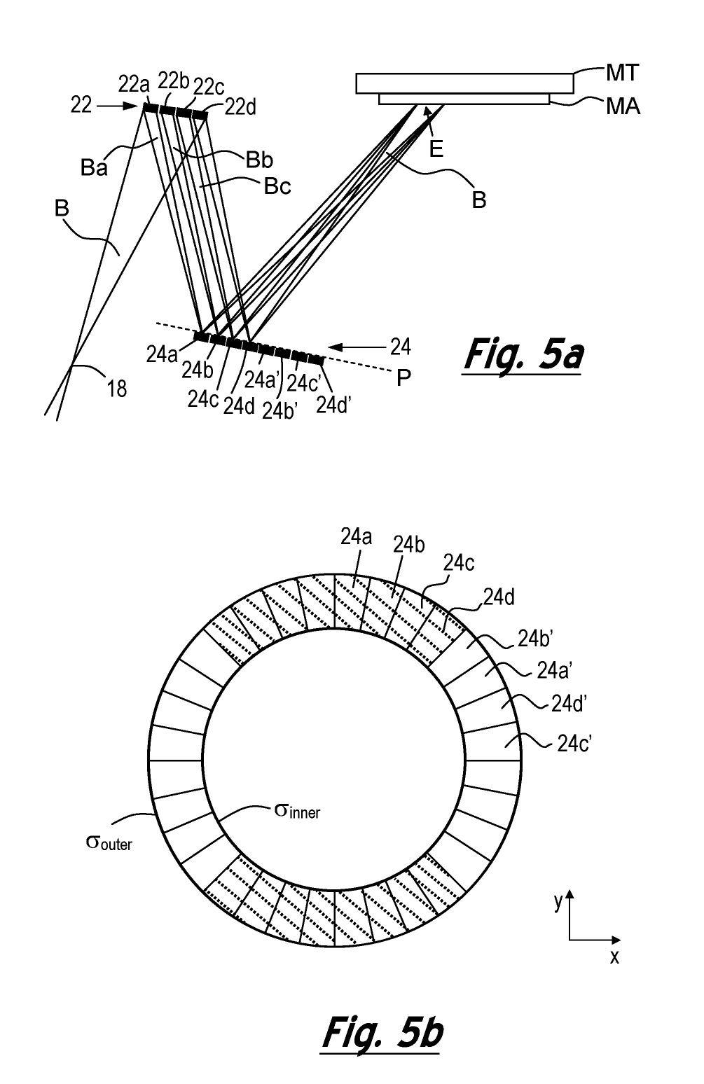

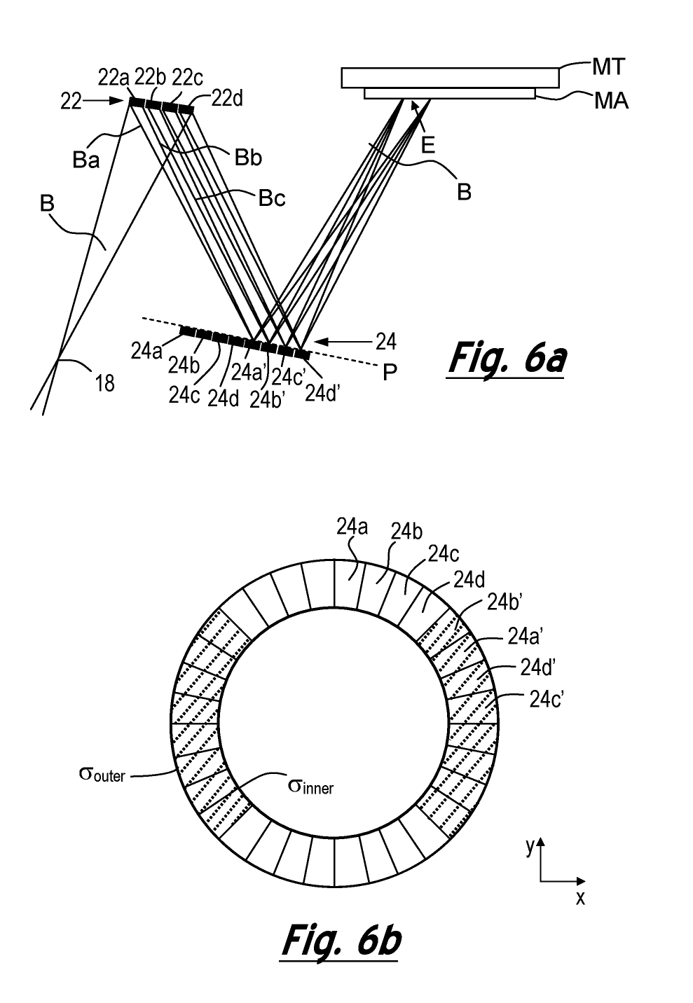

FIGS. 5 and 6 schematically illustrate the principle of redirecting radiation in order to change a spatial intensity distribution at the pupil plane P, and thereby obtain a desired illumination mode. The drawing planes of FIGS. 5b and 6b coincide with the pupil plane P shown in FIGS. 5a and 6a. Cartesian coordinates are indicated in FIGS. 5b and 6b in order to facilitate explanation of the Figures. The indicated Cartesian coordinates are not intended to imply any limitation on the orientation of the spatial intensity distributions that may be obtained. The radial extent of the spatial intensity distributions is defined by σᵢₙₙₑᵣ (inner radial extent) and σₒᵤₜₑᵣ (outer radial extent). The inner and outer radial extents may be circular, or may have some other shape.

As explained above, the spatial intensity distribution (and hence illumination mode) of the radiation beam pupil plane P is determined by the orientations of the primary reflective elements 22a-d. The illumination mode is controlled by selecting and then moving each of the primary reflective elements 22a-d to either its first orientation or its second orientation as required.

In this example there are 16 primary reflective elements, only 4 of which are shown (22a-d). When the primary reflective elements 22a-d are in their first orientations, sub-beams of radiation are reflected towards associated first locations 24a-d, as shown in FIG. 5a. Referring to FIG. 5b, the first locations 24a-d are at or close to the top of FIG. 5b. Other primary reflective elements (not illustrated) are also in their first orientations, and direct sub-beams of radiation to first locations which are at or close to the top of FIG. 5b, and at or close to the bottom of FIG. 5b. Locations which receive sub-beams of radiation are shaded using dotted lines. It can be seen from FIG. 5b that when the primary reflective elements 22a-d are in their first orientations, a dipole illumination mode is formed in which the poles are separated in the y-direction.

When the primary reflective elements 22a-d are in their second orientations, sub-beams of radiation are reflected towards associated second locations 24a′-d′, as shown in FIG. 6a. Referring to FIG. 6b, the second locations 24a′-d′ are at or close to the right hand side of FIG. 6b. Other primary reflective elements (not illustrated) are also in their second orientations, and direct sub-beams of radiation to second locations which are at or close to the right hand side of FIG. 6b, and at or close to the left hand side of FIG. 6b. Locations which receive sub-beams of radiation are shaded using dotted lines. It can be seen from FIG. 6b that when the primary reflective elements 22a-d are in their second orientations, a dipole illumination mode is formed in which the poles are separated in the x-direction.

Switching from the y-direction dipole illumination mode to the x-direction dipole illumination mode is achieved by moving each of the primary reflective elements 22a-d from the first orientation to the second orientation. Similarly, switching from the x-direction dipole illumination mode to the y-direction dipole illumination mode is achieved by moving each of the primary reflective elements 22a-d from the second orientation to the first orientation.

Other modes may be formed by moving some of the primary reflective elements 22a-d to their first orientation and some to their second orientation, as is explained further below. The first orientation and second orientation of each primary reflective element (and consequently the first and second associated locations) may be chosen so as to maximize the number of useful illumination modes that can be produced.

The primary reflective elements may be moved between first orientations and second orientations by rotating them about an axis. The primary reflective elements may be moved using actuators.

One or more primary reflective elements may be configured to be driven to rotate around the same axis. One or more other primary reflective elements may be configured to be driven to rotate around one or more other axes.

In an embodiment, a primary reflective element comprises an actuator arranged to move the primary reflective element between the first orientation and the second orientation. The actuator may be, for example, a motor. The first and second orientations may be defined by end stops. A first end stop may comprise a mechanical apparatus which prevents the primary reflective element from moving beyond the first orientation. A second end stop may comprise a mechanical apparatus which prevents the primary reflective element from moving beyond the second orientation. A suitable mount for the primary reflective element, which includes end stops, is described further below.

Since movement of the primary reflective element is limited by end stops, the primary reflective element can be accurately moved to the first orientation or the second orientation without needing to monitor the position of the primary reflective element (e.g. without needing to use a position monitoring sensor and a feedback system). The primary reflective elements may be oriented sufficiently accurately that they may form illumination modes of sufficient quality to be used in lithographic projection of a pattern from a patterning device onto a substrate.

A driver signal supplied to the actuator may be a binary signal. There is no need to use a more complex signal such as a variable analog voltage or a variable digital voltage, since the actuator only needs to move the primary reflective element to a first end stop or to a second end stop. The use of a binary (two-valued) driver signal for the actuator, rather than a more complex system, allows a more simple control system to be used than would otherwise be the case.

The apparatus described above in relation to FIGS. 5 and 6 includes 16 primary reflective elements. In practice, many more primary reflective elements may be provided. However, 16 primary reflective elements is a sufficient number to allow illustration of the way in which several different illumination modes may be obtained. The following illumination modes may be obtained using 16 primary reflective elements: annular, c-quad, quasar, dipole-y and dipole-x. These illumination modes are formed by configuring the 16 primary reflective elements so as to appropriately direct radiation towards 32 associated locations at the pupil plane of the illumination system.

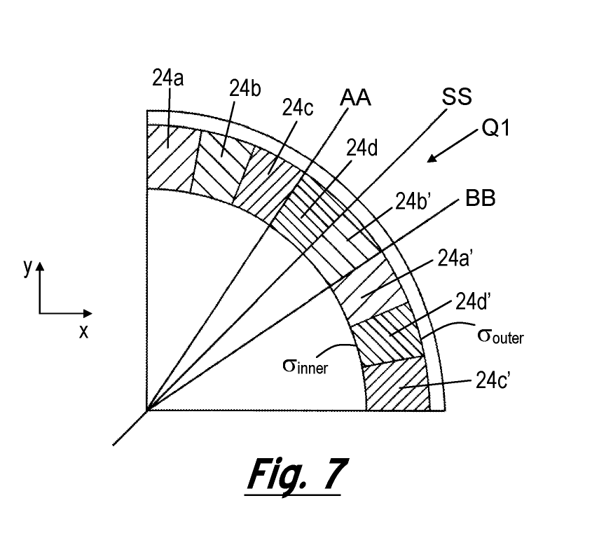

FIG. 7 depicts a first quadrant of a pupil plane Q1 in an illumination system that is configured to produce the five different desired illumination modes. Each segment 24a-d, 24a′-d′ of the quadrant corresponds to an illumination location (i.e. a location which receives a radiation sub-beam from a field facet mirror). The illumination locations are arranged peripherally (e.g., circumferentially) around the pupil plane in an annular shape. An inner radial extent of the illumination locations is labeled as σᵢₙₙₑᵣ. An outer radial extent of the illumination locations is labeled as σₒᵤₜₑᵣ.

A plurality of secondary reflective elements may be provided at each illumination location. For example between 10 and 20 secondary reflective elements may be provided at each illumination location. Where this is the case, the number of primary reflective elements scales accordingly. For example, if there are 10 secondary reflective elements at a given illumination location, then there are 10 primary reflective elements arranged to direct radiation to that illumination location (each of the primary reflective elements being arranged to direct radiation to a different secondary reflective element). In the following description, where the term ‘primary reflective element’ is used, this may encompass a plurality of primary reflective elements which are configured to move in unison.

The relative surface area of illumination locations across the pupil plane amounts to (σₒᵤₜₑᵣ²−σᵢₙₙₑᵣ²)/2. Thus, the etendue ratio X (i.e. the inverse of the relatively used pupil area) follows as X=2/(σₒᵤₜₑᵣ²−σᵢₙₙₑᵣ²).

In the quadrant Q1 depicted in FIG. 7, there are 8 illumination locations 24a-d, 24a′-d′ (corresponding with 32 illumination locations across the entire pupil plane). Each illumination location is sized and shaped to be illuminated by a sub-beam of radiation reflected by a primary reflective element. Each primary reflective element is configured so as to separately illuminate two illumination locations from different parts of the same quadrant. More specifically, each primary reflective element is configured to move between a first orientation and a second orientation so as to direct radiation and thereby illuminate either a first associated illumination location or a second associated illumination location in the same quadrant.

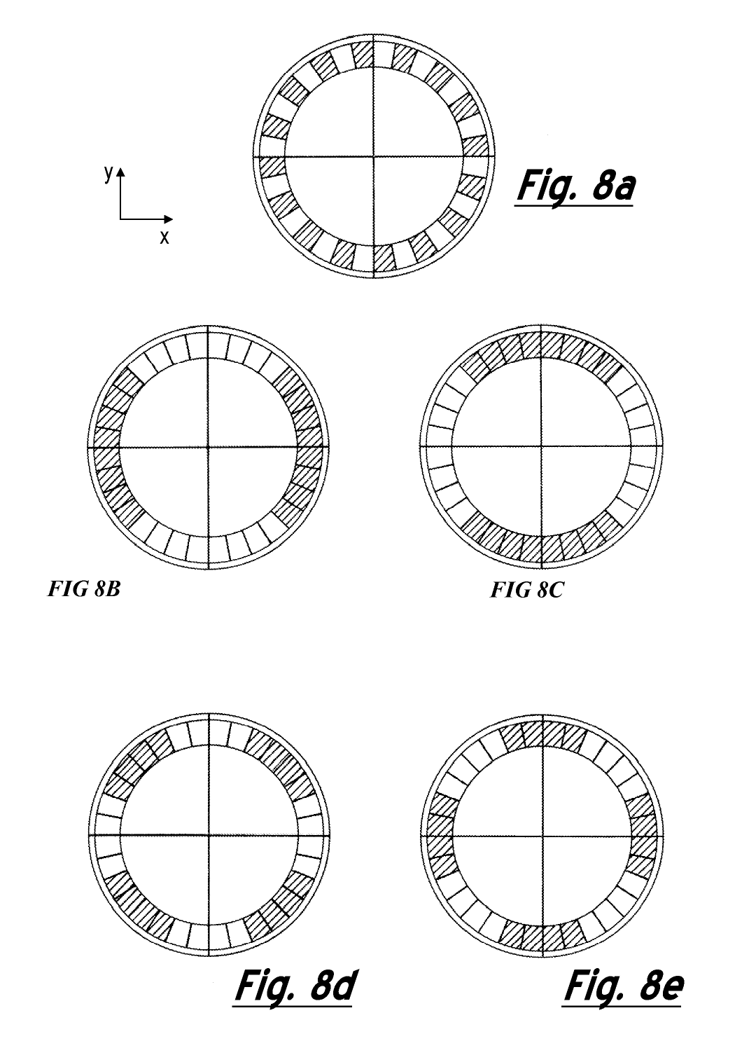

Although pairs of illumination locations 24a,a′ (and others) are provided in the same quadrant Q1 in FIG. 7, it is not necessary that this is the case. For example, a first illumination location may be provided in one quadrant, and its pair may be provided in a different quadrant. If the separation between the first and second illumination locations of a pair of illumination locations is increased, then the amount of rotation required by the primary reflective element in order to direct a radiation sub-beam to those illumination locations will also increase. The positions of the illumination locations may be selected such that the required rotation of the primary reflective elements is minimized, or that none of the primary reflective elements is required to rotate by more than a certain maximum rotation. The positions of the illumination locations may be such that a desired set of illumination modes may be obtained (for example as explained further below in relation to FIG. 8).

A first primary reflective element 22a (see FIGS. 5 and 6) is configured to illuminate a first associated illumination location 24a of the quadrant Q1 when orientated in a first orientation, and a second associated illumination location 24a′ of the quadrant when orientated in a second orientation. A second primary reflective element 22b is configured to illuminate a first associated illumination location 24b when orientated in a first orientation and a second associated illumination location 24b′ when orientated in a second orientation. A third primary reflective element 22c is configured to illuminate a first associated illumination location 24c when orientated in a first orientation and a second associated illumination location 24c′ when orientated in a second orientation. A fourth primary reflective element 22d is configured to illuminate a first associated illumination location 24d when orientated in a first orientation and a second associated illumination location 24d′ when orientated in a second orientation.

An equivalent arrangement of the illumination locations and associated primary reflective regions may apply for other quadrants (not illustrated).

Each primary reflective element may be moved between the first orientation and second orientation by rotating it about a certain axis. A plurality of primary reflective elements may be configured so as to rotate about the same axis. For example, primary reflective elements associated with adjacent illumination locations in the same quadrant of the pupil plane may be configured so as to rotate about the same axis. In the illustrated example, the first and second primary reflective elements 22a, 22b are configured to rotate about a first axis AA, and the third and fourth primary reflective elements 22c, 22d are configured to rotate about second axis BB. The first axis AA is arranged at 56.25° with respect to the x-axis in Q1, and the second axis BB is arranged at 33.75° with respect to the x-axis in Q1. Although the first and second axes AA, BB are shown in the plane of FIG. 7, this is for ease of illustration only. The axes will be in the plane of the primary reflective elements 22a-d.

Additionally or alternatively, primary reflective elements associated with corresponding illumination locations in opposing quadrants of the pupil plane may be configured to rotate about the same axis. For example, primary reflective elements 22a,b associated with the first quadrant Q1 and corresponding primary reflective elements associated with a third quadrant may be configured to rotate about the first axis AA. Likewise, primary reflective elements 22c,d associated with the first quadrant Q1 and corresponding primary reflective elements associated with the third quadrant may be configured to rotate about the second axis BB.

Primary reflective elements associated with a second quadrant, and primary reflective elements associated with a fourth quadrant, may be rotated about a third axis (e.g. arranged at 123.75° with respect to the x axis). In addition, primary reflective elements associated with the second quadrant and primary reflective elements associated with the fourth quadrant may be rotated about a fourth axis (e.g. arranged at 146.25° with respect to the x axis). Neither of these quadrants are shown in FIG. 7.

The primary reflective elements may be configured to rotate in the same direction or opposite directions about same axis.

When primary reflective elements are grouped together to rotate about the same axis, and to rotate in the same direction, an actuator arranged to move the primary reflective elements between their first and second orientations may be simplified. For example, an actuator associated with primary reflective elements that are grouped to rotate about the same axis may be arranged to move those primary reflective elements in unison. Thus, in an embodiment in which there are four axes of rotation, there may be four actuators.

FIG. 8 shows how five different illumination modes may be formed at the pupil plane of the illumination system, using the described apparatus (i.e. using 16 primary reflective elements and 4 axes of rotation). The illumination modes are as follows: annular illumination mode (FIG. 8a), dipole-x illumination mode (FIG. 8b), dipole-y illumination mode (FIG. 8c), quasar illumination mode (FIG. 8d) and c-quad illumination mode (FIG. 8e).

To produce the annular illumination mode, as shown in FIG. 8a, the primary reflective elements 22a-d associated with the first quadrant are oriented such that illumination locations 24b, 24d, 24a′ and 24c′ (see FIG. 7) are illuminated. This is achieved by rotating the first primary reflective element 22a around the first axis AA to its second orientation, rotating the second primary reflective element 22b around the first axis AA to its first orientation, rotating the third primary reflective element 22c around the second axis BB to its second orientation, and rotating the fourth primary reflective element 22d around the second axis BB to its first orientation. The primary reflective elements associated with the illumination locations of the second, third and fourth quadrants are similarly orientated.

To produce a dipole-x illumination mode, as shown in FIG. 8b (see also FIG. 6b), the primary reflective elements associated with the first quadrant are orientated such that illumination locations 24b′,24a′, 24d′ and 24c′ are illuminated. This is achieved by rotating the first primary reflective element 22a around the first axis AA to its second orientation, rotating the second primary reflective element 22b around the first axis AA to its second orientation, rotating the third primary reflective element 22c around the second axis BB to its second orientation, and rotating the fourth primary reflective element 22d around the second axis BB to its second orientation. The primary reflective elements associated with the illumination locations of the second, third and fourth quadrants are similarly orientated.

To produce a dipole-y illumination mode, as shown in FIG. 8c (see also FIG. 5b), the primary reflective elements associated with the first quadrant are orientated such that illumination locations 24a, 24b, 24c and 24d are illuminated. This is achieved by rotating the first primary reflective element 22a around the first axis AA to its first orientation, rotating the second primary reflective element 22b around the first axis AA to its first orientation, rotating the third primary reflective element 22c around the second axis BB to its first orientation, and rotating the fourth primary reflective element 22d around the second axis BB to its first orientation. The primary reflective elements associated with the illumination locations of the second, third and fourth quadrants are similarly orientated.

To produce a quasar illumination mode, as shown in FIG. 8d, the primary reflective elements associated with the first quadrant are orientated such that illumination locations 24c, 24d, 24b′ and 24a′ are illuminated. This is achieved by rotating the first primary reflective element 22a around the first axis AA to its second orientation, rotating the second primary reflective element 22b around the first axis AA to its second orientation, rotating the third primary reflective element 22c around the second axis BB to its first orientation, and rotating the fourth primary reflective element 22d around the second axis BB to its first orientation. The primary reflective elements associated with the illumination locations of the second, third and fourth quadrants are similarly orientated.

To produce a c-quad illumination mode, as shown in FIG. 8e, the primary reflective elements associated with the first quadrant are oriented such that illumination locations 24a, 24b, 24d′ and 24c′ are illuminated. This is achieved by rotating the first primary reflective element 22a around the first axis AA to its first orientation, rotating the second primary reflective element 22b around the first axis AA to its first orientation, rotating the third primary reflective element 22c around the second axis BB to its second orientation and rotating the fourth primary reflective element 22d around the second axis BB to its second orientation. The primary reflective elements associated with the illumination locations of the second, third and fourth quadrants are similarly orientated.

In the above description of the illumination modes shown in FIG. 8, it has been mentioned that the primary reflective elements associated with the illumination locations of the second, third and fourth quadrants are orientated similarly to the first quadrant. The following explains the manner in which this is done. It can be seen from FIG. 8 that the dipole, quasar and c-quad modes are symmetric about the x and y axes. The annular mode of FIG. 8a however is not symmetric about the x and y axes, although it is rotationally symmetric (for rotations of 90° or multiples thereof).

The fact that illumination modes do not share the same symmetry applies a constraint to the positions of the illumination locations. The constraint is that each pair of illumination locations has an associated pair of illumination locations, and the two pairs are symmetric about a line SS which bisects the quadrant (see FIG. 7). For example, the first pair of illumination locations 24a,a′ is associated with the third pair of illumination locations 24c,c′. These two pairs are symmetric about the line SS. The second pair of illumination locations 24b,b′ is associated with the fourth pair of illumination locations 24d,d′. These two pairs are also symmetric about the line SS. The same constraint is applied to the other quadrants.

The second quadrant is a mirror image of the first quadrant. The third and fourth quadrants are mirror images of the first and second quadrants. Positioning the illumination locations in this manner allows all of the illumination modes shown in FIG. 8 to be achieved. When any of the illumination modes shown in FIGS. 8b-d are to be produced, the orientations of corresponding primary reflective elements for each quadrant are the same. When the annular mode of FIG. 8a is to be produced, the orientations of the primary reflective elements for the first and third quadrants are opposite to those applied to the primary reflective elements for the second and fourth quadrants.

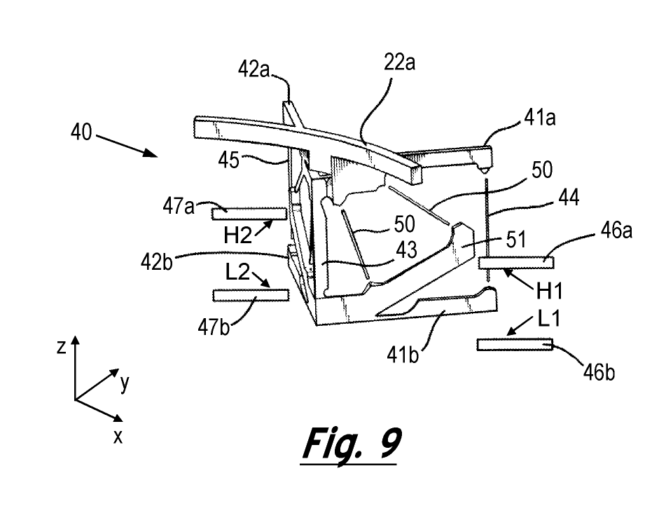

The primary reflective elements may be provided on mountings which allow for rotation about two axes. A mounting 40 which may be used is illustrated in FIG. 9. Cartesian coordinates are shown in FIG. 9 in order to assist in describing the mounting. A primary reflective element 22a is held on the mounting 40. The mounting 40 comprises two lever arms 41a, 41b extending in the x-direction, and two lever arms 42a, 42b extending in the y-direction. A pillar 43 extends in the z-direction and connects inner ends of the lever arms 41a,b, 42a,b together via leaf springs. Outer ends of the first pair of lever arms 41a,b are connected by a first rod 44 which maintains a constant separation between the outer ends. Outer ends of the second pair of lever arms 42a,b are connected by a second rod 45 which maintains a constant separation between the outer ends.

The first pair of lever arms 41a,b is configured to rotate the primary reflective element 22a about a first axis. End stops 46a,b limit the range of movement of the first pair of lever arms 41a,b. The end stops 46a,b establish two positions between which the lowermost lever arm 41b may move. The two positions are a high position (referred to as H1) and a low position (referred to as L1). When the lowermost lever arm 41b is in the high position H1, it is in contact with the upper end stop 46a. When the lowermost lever arm 41b is in the low position L1, it is contact with the lower end stop 46b.

The connection provided by the first rod 44 between the uppermost lever arm 41a and the lowermost lever arm 41b links movement of the uppermost and lowermost lever arms together. Movement of the uppermost lever arm 41a is therefore limited by the end stops 46a,b. Since the primary reflective element 22a is connected to the uppermost lever arm 41a, this means that rotation of the primary reflective element 22a about the first axis is limited by the end stops 46a,b. The rotation of the primary reflective element 22a about the first axis is thus limited to a position in which the lowermost lever arm 41b is in contact with upper end stop 46a, and a position in which the lowermost lever arm 41b is in contact with the lower end stop 46b.

The second pair of lever arms 42a,b is configured to rotate the primary reflective element 22a about a second axis which is orthogonal to the first axis. End stops 47a, 47b are used to limit the movement of the second pair of lever arms 42a,b. The second pair of lever arms move between a high position (H2) and a lower position (L2). The rotation of the primary reflective element 22a about the second axis is thus limited to a position in which the lowermost lever arm 42b is in contact with upper end stop 47a, and a position in which the lowermost lever arm 42b is in contact with the lower end stop 47b.

If both pairs of lever arms 41a,b, 42a,b are moved in the same direction to the same extent, then a rotation of the primary reflective element 22a about the x-axis is obtained. If the pairs of lever arms 41a,b, 42a,b are moved in opposite directions to the same extent, then a rotation of the primary reflective element 22a about the y-axis is obtained.

Flexible rods 50 extend from a rigid arm 51 which lies in a plane defined by the first pair of lever arms 41a,b. Equivalent flexible rods (not labeled) extend from a rigid arm (not labeled) which lies in a plane defined by the second pair of lever arms 42a,b. The flexible rods are used to define the pivot point of the mounting. The pivot point is located where the flexible rods cross.

The configuration of the mounting 40 allows four possible first orientations of the primary reflective element 22a, and four corresponding second orientations. These are as follows:

| | | | | |
|---|---|---|---|---|
| Orientation 1: | H1, H2 | H1, L2 | L1, H2 | L1, L2 |
| Orientation 2: | L1, L2 | L1, H2 | H1, L2 | H1, H2 |

The locations illuminated at the pupil plane P (see FIGS. 3-6) will vary according to the orientation of the primary reflective element 22a. This allows different illumination modes to be selected, in the manner described further above.

If each of the four primary reflective elements 22a-d are rotated using the mounting of FIG. 9, then the positions of the lever arms may be as follows:

| | Element 22a | Element 22b | Element 22c | Element 22d |
|---|---|---|---|---|
| Annular Mode | HL | LH | HL | LH |
| x-Dipole Mode | HL | HL | HL | HL |
| y-Dipole Mode | LH | LH | LH | LH |
| Quasar Mode | LH | LH | HL | HL |
| C-Quad Mode | HL | HL | LH | LH |

It is possible to adjust the axis of rotation of the first primary reflective element 22a by adjusting the positions of the end stops 46a,b, 47a,b, 50. The end stops may be positioned for example such that the axis of rotation of the first primary reflective element corresponds with axis AA of FIG. 7. Similarly, the end stops may be positioned for example such that the axis of rotation of the third primary reflective element 22c corresponds with axis BB of FIG. 7.

The lever arms 41a,b, 42a,b may be driven by an actuator (not shown). The actuator may be, for example, a motor. Each lever arm pair 41a,b, 42a,b may be driven by a different dedicated actuator. Thus, eight actuators may be used to drive lever arms to rotate the four primary reflective elements 22a-d associated with the illumination locations 24a-d, 24a′-d′ of quadrant Q1 in FIG. 7.

Alternatively, both lever arm pairs 41a,b, 42a,b may be driven by a single actuator, which may for example be configured to provide both direct and inverted motion. Where this is the case, four motors may be used to drive the lever arms to rotate the four primary reflective elements 22a-d associated with the illumination locations 24a-d, 24a′-d′ of quadrant Q1 in FIG. 7.

A plurality of primary reflective elements may be used instead of the first primary reflective element 22a. Where this is the case, the plurality of primary reflective elements may each be provided on a mounting 40. The mountings 40 may be driven by actuators which are arranged such that the plurality of primary reflective elements move in unison. The same applies to other primary reflective elements 22b-d.

The actuator may be simple because the actuator is only required to drive the primary reflective element to two positions. Actuators that drive reflective elements to a larger number of positions require more accurate control. Since the actuator is only required to drive the primary reflective element to two positions, sensing systems are not needed to determine the orientation of the primary reflective element. Furthermore, binary signals may be used to control the positions of the reflective elements, rather than using multi-valued (analog) signals.

The actuator may for example be a piezo-electric actuator, electrostatic actuator, a bi-metal actuator, or a motor.

It may be possible to arrange the primary reflective elements more closely together than in conventional prior art arrays of reflective elements. This is because each primary reflective element is only moved between two positions, and therefore does not require space around its periphery which would allow it to move to other different positions. This closer arrangement of the primary reflective elements reduces loss of radiation in the lithographic apparatus. This is because spaces between the primary reflective elements into which radiation may pass are smaller.

In the above described embodiment, the illumination locations which are illuminated by radiation sub-beams all have the same inner radial extent (σᵢₙₙₑᵣ) and outer radial extent (σₒᵤₜₑᵣ) (e.g. they all lie in a single ring). This is illustrated for example in FIG. 7, where all of the illumination locations 24a-d, 24a′-d′ of quadrant Q1 are shown with the same inner and outer radial extents. In addition, the axes of rotation of the primary reflective elements all pass through the origin of the quadrant (i.e. the optical axis of the illumination system).

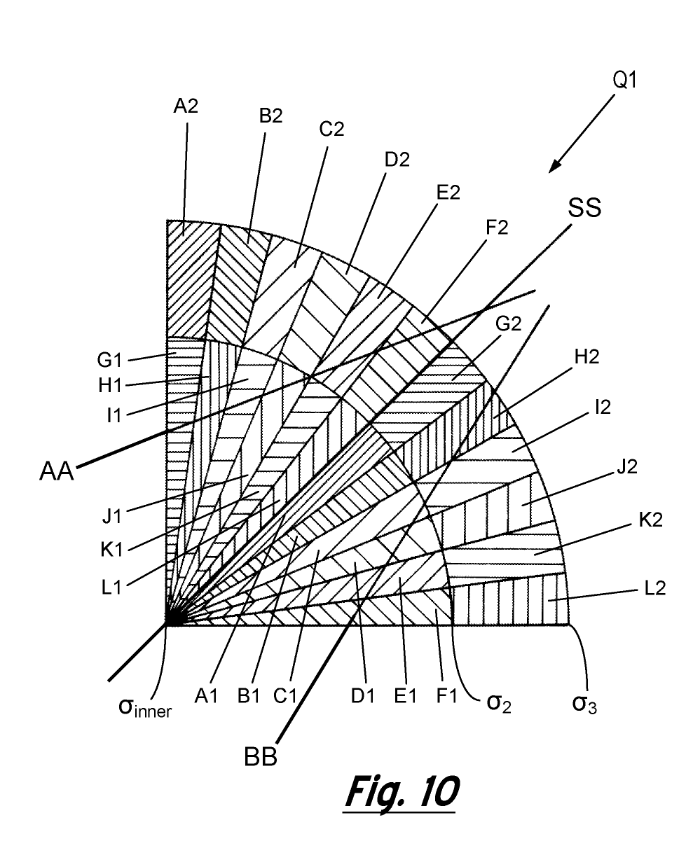

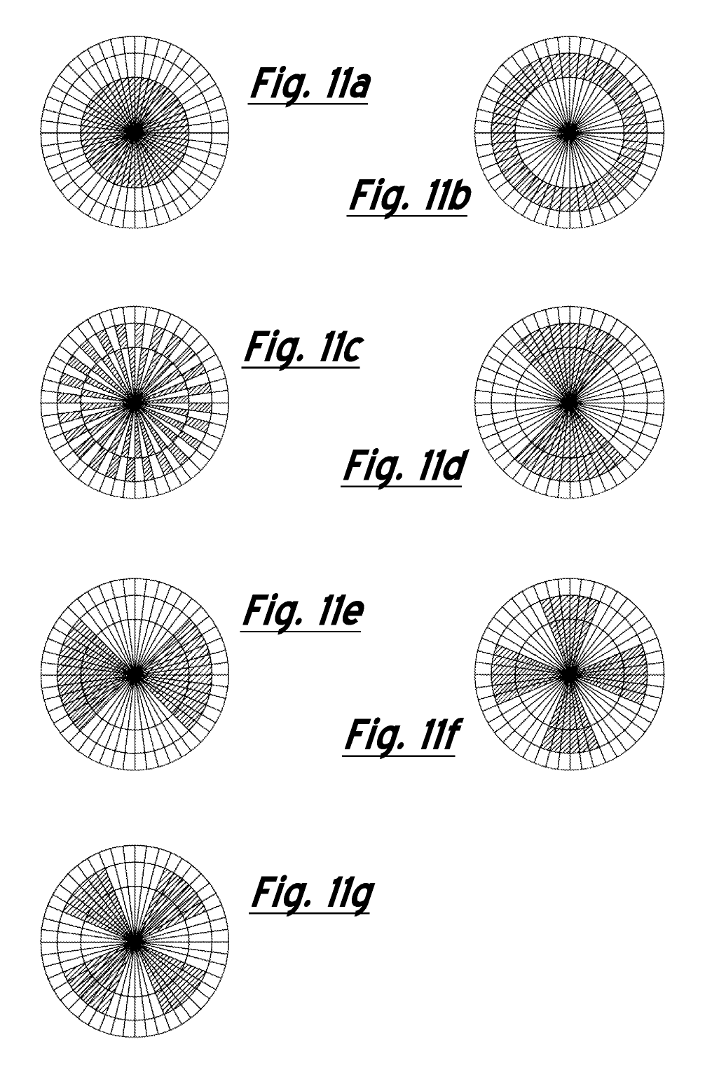

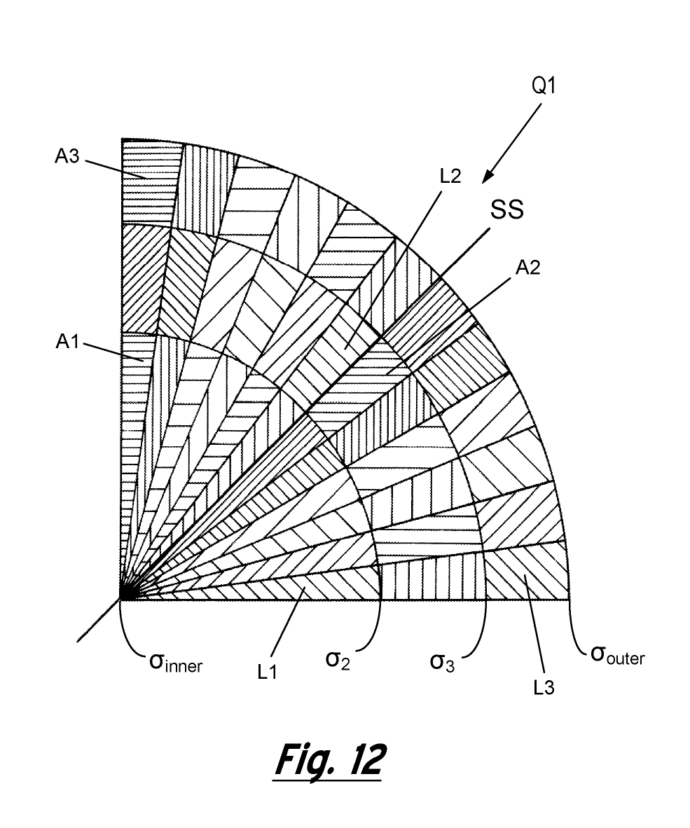

In a further embodiment, the illumination locations which are illuminated by radiation sub-beams may for example be provided as a disk and a ring, the ring lying adjacent to the disk. FIG. 10 depicts a first quadrant of a pupil plane Q1 with this arrangement of illumination locations. There are 24 illumination locations A1, A2 to L1, L2 in the quadrant Q1 (96 illumination locations across the entire pupil plane). 12 primary reflective elements A to L (not shown) are configured to illuminate the associated 24 illumination locations of the quadrant Q1 (48 primary reflective elements are configured to illuminate all of the illumination locations).

A plurality of secondary reflective elements may be provided at each illumination location. For example between 10 and 20 secondary reflective elements may be provided at each illumination location. Where this is the case, the number of primary reflective elements scales accordingly. For example, if there are 10 secondary reflective elements at a given illumination location, then there are 10 primary reflective elements arranged to direct radiation to that illumination location (each of the primary reflective elements being arranged to direct radiation to a different secondary reflective element). In this description, where the term ‘primary reflective element’ is used, this may encompass a plurality of primary reflective elements which are configured to move in unison.

The illumination locations may be classified as an inner illumination location group and an outer illumination location group. The illumination locations in the inner illumination location group are illuminated when associated primary reflective elements are in their first orientations. The illumination locations in the outer illumination location group are illuminated when associated primary reflective elements are arranged in their second orientations.

The inner illumination location group has an inner radial extent σᵢₙₙₑᵣ and an outer radial extent σ₂. The outer illumination location group has an inner radial extent σ₂ and an outer radial extent σ₃.

The relative surface area of the illumination locations across the pupil plane amounts to (σ₃²−σᵢₙₙₑᵣ²)/2. Thus, the etendue ratio X (i.e. the inverse of the relatively used pupil area) follows as X=2/(σ₃²−σᵢₙₙₑᵣ²).

Each primary reflective element is configured so as to separately illuminate two illumination locations from different parts of the same quadrant (e.g. Q1). More specifically, each first reflective element is configured to move between a first orientation and a second orientation. When the first reflective element is in the first orientation, a radiation sub-beam is directed towards a first associated illumination location in the outer illumination location group. When the first reflective element is in the second orientation, the radiation sub-beam is directed towards a second associated illumination location in the inner illumination location group (both locations being in the same quadrant).

Referring to FIG. 3 and FIG. 10, a primary reflective element 22a may be configured to illuminate a first associated illumination location A1 when in its first orientation, and to illuminate a second associated illumination location A2 when in its second orientation. A different primary reflective element 22b may be configured to illuminate a first associated illumination location B1 when in its first orientation, and a second associated illumination location B2 when in its second orientation. Other primary reflective elements may be configured in the respective same way.

A constraint is applied to the positions of the illumination locations. The constraint is that each pair of illumination locations has an associated pair of illumination locations, and the two pairs are symmetric about a line SS which bisects the quadrant. For example, the first pair of illumination locations A1, A2 is associated with a seventh pair of illumination locations G1, G2. These two pairs are symmetric about the line SS. In a second example, the second pair of illumination locations B1, B2 is associated with the fourth pair of illumination locations H1, H2. These two pairs are also symmetric about the line SS. The same constraint is applied to the other pairs of illumination locations. Furthermore, the same constraint is applied to the other quadrants.

The configuration of the illumination locations and associated primary reflective regions may be the same for each of the quadrants of the pupil plane. For example, the second quadrant may be a mirror image of the first quadrant. The third and fourth quadrants may be mirror images of the first and second quadrants.

Each of the primary reflective elements may be moved between a first orientation and a second orientation by rotating it about an axis. Rotation may be limited by end-stops. In order to radiate an illumination location in the outer illumination group and an illumination location in the inner illumination group, it may be the case that the axis does not pass through the optical axis of the illumination system.

Referring to FIG. 3 and FIG. 10, a first primary reflective element 22a which illuminates first associated illumination locations A1, A2 may rotate about a first axis AA. A second primary reflective element 22b which illuminates second associated illumination locations L1, L2 may rotate about a second axis BB. Other primary reflective elements may rotate about other axes (not illustrated). In total there are 12 axes of rotation for the first quadrant Q1. Rotation axes for the third quadrant are parallel to those for the first quadrant. There are 12 rotation axes for the second quadrant, and these are parallel to the rotation axes for the fourth quadrant. In total therefore there are 24 rotation axes.

Primary reflective elements associated with corresponding illumination locations in opposing quadrants of the pupil plane may be configured to rotate about the same axis. In the example depicted in FIG. 10, there may for example be 12 axes of rotation in total. This comprises 6 axes extending across Q1 and Q3, and 6 axes extending across Q2 and Q4.

The primary reflective elements may be used to produce seven different illumination modes. The illumination modes are shown in FIG. 11. The illumination modes are: a conventional (disk) mode, an annular mode, a second disk mode, dipole modes and quadrupole modes.

To produce the conventional (disk) mode, shown in FIG. 11a, the primary reflective elements associated with the quadrant Q1 are orientated such that illumination locations A1 to L1 are illuminated. This is achieved by rotating every primary reflective element about its axis to its first orientation. The primary reflective elements associated with the illumination locations of the second, third and fourth quadrants are similarly orientated. If the inner radial extent σᵢₙₙₑᵣ were not zero, but was instead a finite value, then this mode would be an annular mode rather than the conventional (disk) mode.

To produce the annular illumination mode, shown in FIG. 11b, the primary reflective elements associated with the quadrant Q1 are orientated such that illumination locations A2 to L2 are illuminated. This is achieved by rotating every primary reflective element about its axis to its second orientation. The primary reflective elements associated with the illumination locations of the second, third and fourth quadrants are similarly orientated.

To produce the second disk illumination mode, as shown in FIG. 11c, the primary reflective elements associated with quadrant Q1 are orientated such that illumination locations A2, B1, C2, D1, E2, F1, G2, H1, I2, J1, K2 and L1 are illuminated. This is achieved by rotating those primary reflective elements associated with illumination locations A, C, E, G, I and K about their axes to their second orientations, and rotating primary reflective elements associated with illumination locations B, D, F, H, J and L about their axes to their first orientations. The primary reflective elements associated with the illumination locations of the second, third and fourth quadrants are similarly orientated.

To produce a y-dipole mode illumination mode, as shown in FIG. 11d, the primary reflective elements associated with quadrant Q1 are orientated such that illumination locations A2 to F2 and G1 to L1 are illuminated. This is achieved by rotating primary first reflective elements associated with illumination locations A to F around their axes to their second orientations, and rotating primary reflective elements associated with illumination locations G to L around their axes to their first orientations. The primary reflective elements associated with the illumination locations of the second, third and fourth quadrants are similarly orientated.

To produce an x-dipole illumination mode, as shown in FIG. 11e, the primary reflective elements associated with quadrant Q1 are orientated such that illumination locations A1 to F1 and G2 to L2 are illuminated. This is achieved by rotating primary reflective elements associated with illumination locations A to F around their axes to their first orientations, and rotating primary reflective elements associated with illumination locations G to L around their axes to their second orientations. The primary reflective elements associated with the illumination locations of the second, third and fourth quadrants are similarly orientated.

To produce a quadrupole illumination mode, as shown in FIG. 11f, the first reflective elements associated with quadrant Q1 are orientated such that illumination locations D1 to I1, J2 to L2 and A2 to C2 are illuminated. This is achieved by rotating primary reflective elements associated with illumination locations D to I around their axes to their first orientations, and rotating primary reflective elements associated with illumination locations J to L and A to C about their axes to their second orientations. The primary reflective elements associated with the illumination locations of the second, third and fourth quadrants are similarly orientated.

To produce an alternative quadrupole illumination mode, as shown in FIG. 11g, the primary reflective elements associated with the quadrant Q1 are orientated such that illumination locations A1 to C1, G2 to I2, J1 to L1 and D2 to F2 are illuminated. This is achieved by rotating primary reflective elements associated with illumination locations A to C and J to L around their axes to their first orientations, and rotating primary reflective elements associated with illumination locations G to I and D to F around their axes to their second orientations. The primary reflective elements associated with the illumination locations of the second, third and fourth quadrants are similarly orientated.

The primary reflective elements may also be oriented to produce other desired illumination modes at the pupil plane.

In a further embodiment, the illumination locations which are illuminated by radiation sub-beams may be provided as a disk, a first ring and a second ring. The first ring may lie adjacent to the disk, and the second ring may lie adjacent to the first ring. FIG. 12 depicts a first quadrant of a pupil plane Q1 with this arrangement of illumination locations. There are 36 illumination locations in the quadrant Q1 (144 illumination locations across the entire pupil plane). 12 primary reflective elements (not shown) are configured to illuminate the associated 36 secondary reflective elements of the quadrant Q1 (48 primary reflective elements are configured to illuminate all of the illumination locations).

A plurality of secondary reflective elements may be provided at each illumination location. For example between 10 and 20 secondary reflective elements may be provided at each illumination location. Where this is the case, the number of primary reflective elements scales accordingly. For example, if there are 10 secondary reflective elements at a given illumination location, then there are 10 primary reflective elements arranged to direct radiation to that illumination location (each of the primary reflective elements being arranged to direct radiation to a different secondary reflective element). In the following description, where the term ‘primary reflective element’ is used, this may encompass a plurality of primary reflective elements which are configured to move in unison.

Each primary reflective element is configured to be moveable between three different orientations, in order to direct radiation at three different illumination locations. For example, a first primary reflective element is moveable between a first orientation which directs radiation to a first illumination location A1, a second orientation which directs radiation to a second illumination location A2, and a third orientation which directs radiation to a third illumination location A3. Other primary reflective elements work in the same manner. However, most illumination locations are not labeled in FIG. 12, in order to avoid overcomplicating the Figure.

Each trio of illumination locations has an associated trio of illumination locations, and two trios are symmetric about a line SS which bisects the quadrant. For example a first trio A1-3 is associated with a twelfth trio L1-3. This pair of trios is symmetric about the line SS. Other trios are paired in the same manner.

The configuration of the illumination locations and associated primary reflective regions may be the same for each of the quadrants of the pupil plane. The second quadrant may be a mirror image of the first quadrant. The third and fourth quadrants may be a mirror image of the first and second quadrants.

The illumination locations may be classified as an inner illumination location group, an intermediate illumination location group, and an outer illumination location group. The illumination locations in the inner illumination location group are illuminated when associated primary reflective elements are in their first orientations. The illumination locations in the intermediate illumination location group are illuminated when associated primary reflective elements are arranged in their second orientations. The illumination locations in the outer illumination location group are illuminated when associated primary reflective elements are arranged in their third orientations.

The inner illumination location group has an inner radial extent σᵢₙₙₑᵣ and an outer radial extent σ₂. The intermediate illumination location group has an inner radial extent σ₂ and an outer radial extent σ₃. The outer illumination location group has an inner radial extent σ₂ and an outer radial extent σₒᵤₜₑᵣ.

The relative surface area of the illumination locations across the pupil plane amounts to (σₒᵤₜₑᵣ²−σᵢₙₙₑᵣ²)/3. Thus, the etendue ratio X (i.e. the inverse of the relatively used pupil area) follows as X=3/(σₒᵤₜₑᵣ²−σᵢₙₙₑᵣ²).

In the arrangement shown in FIG. 12, the inner radial extent σᵢₙₙₑᵣ of the inner illumination location group is zero. The illumination locations in the inner illumination group extend to a central point, thereby forming a disk. In other arrangements the inner radial extent of the inner illumination location group σᵢₙₙₑᵣ may be a non-zero number, in which case the illumination locations of the inner illumination group will form an annulus rather than a disk.

The primary reflective elements move between three different orientations. For this reason, control of the orientation of the primary reflective elements may be more difficult than in the case where the primary reflective elements move between only two different orientations. The primary reflective elements may for example comprise mirrors mounted such that they may rotate independently about two different axes. The orientation of the mirrors may for example be controlled by applying voltages to plates provided on a substrate which supports the mirrors. Mirrors of this type, and control systems which may be used to control the mirrors, are known in the art and are therefore not described further here.

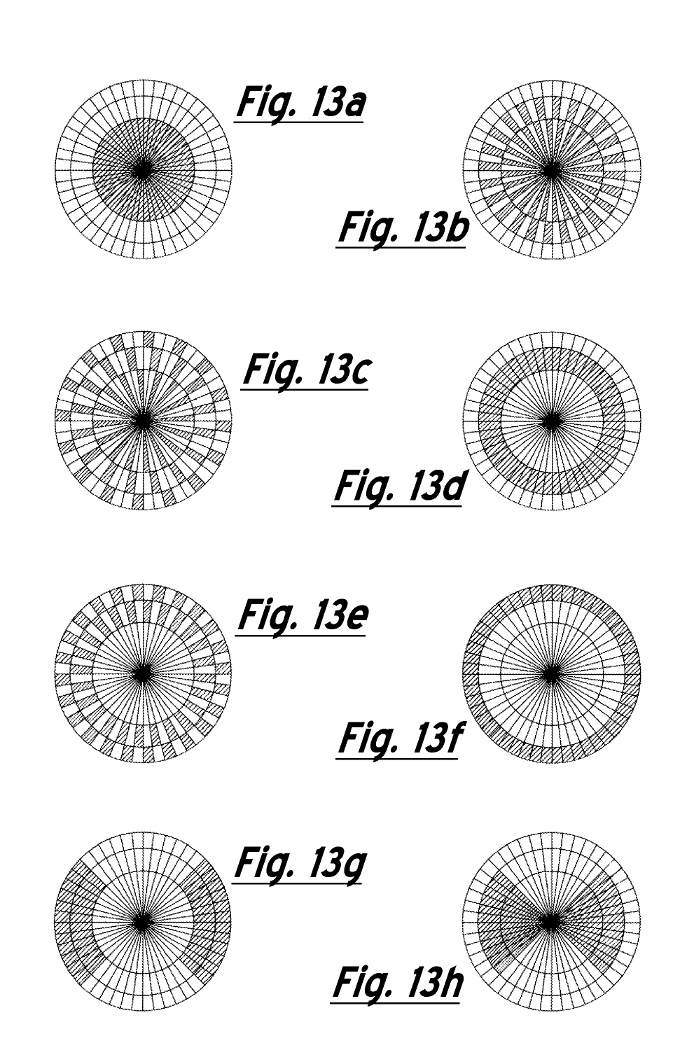

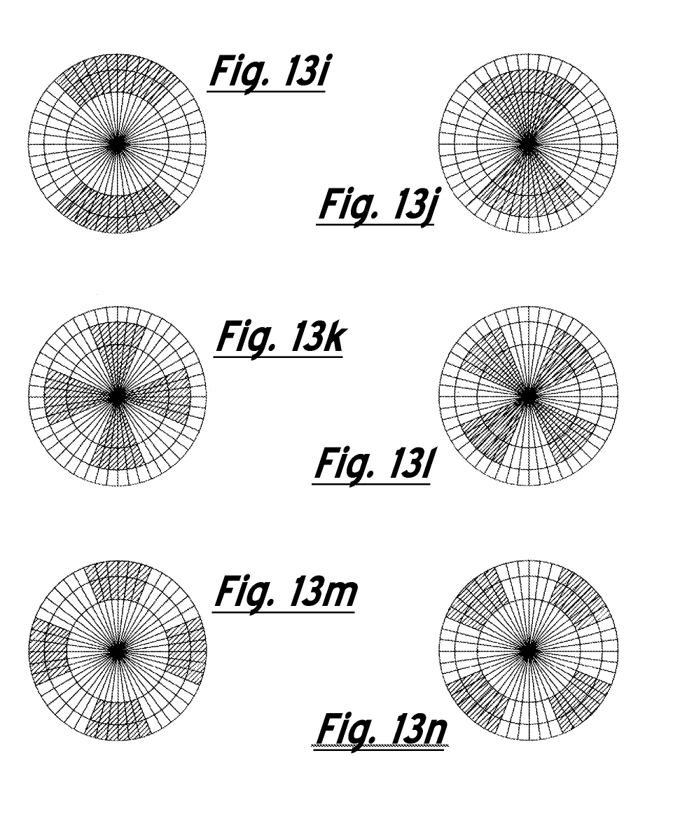

The embodiment illustrated in FIG. 12 may be used to generate a variety of illumination modes, as shown in FIG. 13. The required orientations of the primary reflective elements are not described, since this would lead to a very lengthy description. The orientations may be determined by referring to FIGS. 12 and 13 in combination. The illumination modes shown in FIG. 13 are as follows:

Conventional (disk) illumination modes of different diameters (FIGS. 13a-c);

Annular illumination modes with different inner radial extent σᵢₙₙₑᵣ and outer radial extent σₒᵤₜₑᵣ. (FIGS. 13d-f);

Dipole illumination modes with different inner radial extent σᵢₙₙₑᵣ and outer radial extent σₒᵤₜₑᵣ. (FIGS. 13g-j);

Quadrupole illumination modes (FIGS. 13k-l); and

C-quad illumination modes (FIGS. 13m-n).

As has been explained further above, the cost and complexity of providing an array of primary reflective elements which are capable of being moved to three different orientations, is significantly greater than the cost and complexity of providing an array of primary reflective elements which are movable to only two orientations. Furthermore, the cost of providing an array of primary reflective elements moveable between two orientations is significantly greater than the cost and complexity of providing an array of fixed primary reflective elements. It may therefore be the case that a user of a lithographic apparatus wishes to purchase a lithographic apparatus with an array of fixed primary reflective elements, and then at a later date wishes to ‘upgrade’ the lithographic apparatus to an array of primary reflective elements moveable between two orientations. The user may subsequently wish to upgrade the lithographic apparatus to an array of primary reflective elements moveable between three orientations. Thus, an ‘upgrade path’ may be followed by the user of the lithographic apparatus may be provided.

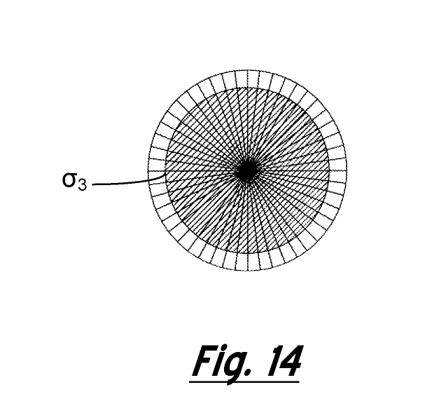

The first point of the upgrade path may comprise an array of primary reflective elements which are fixed, and which are orientated such that they generate a conventional (disc shaped) illumination mode, shown in FIG. 14.

Each illumination location has twice the surface area of each illumination location described above in relation to FIGS. 10 to 13. For this reason, each secondary reflective element may have a surface area which is twice as large as the surface area of a secondary reflective element provided in the embodiments described in relation to FIGS. 10 to 13. Since the secondary reflective elements are larger, the accuracy with which the primary reflective elements must be oriented in order to direct radiation onto the secondary reflective elements is reduced.

In one example, 350 secondary reflective elements are used at the first point in the upgrade path. This corresponds with 350 primary reflective elements.

The second point on the upgrade path is an array of primary reflective elements which are moveable between first and second orientations. These primary reflective elements may be used to form the various illumination modes shown in FIG. 11. One of the illumination modes which may be obtained using the moveable primary reflective elements is the conventional (disc shaped) illumination mode shown in FIG. 11c (i.e. the mode provided by the fixed primary reflective elements of the first point on the upgrade path). This is advantageous for reasons described further below.

The illumination mode of FIG. 11c has the same outer radial extent σ₃ as the illumination mode shown in FIG. 14. Not all illumination locations of this mode are illuminated. However, the illumination mode effectively has the same properties as the illumination mode of FIG. 14.

At the second point on the upgrade path, each illumination location has half the surface area of each illumination location described above in relation to FIG. 14. For this reason, each secondary reflective element may have a surface area which is half is large as the surface area of a secondary reflective element provided in the embodiment described in relation to FIG. 14. Since the secondary reflective elements are smaller, the accuracy with which the primary reflective elements must be oriented in order to direct radiation onto the secondary reflective elements is increased.

In one example, 700 secondary reflective elements are used at the second point in the upgrade path. This corresponds with 350 primary reflective elements.

The third point on the upgrade path is an array of primary reflective elements which are moveable between three orientations. These primary reflective elements may be used to form the various illumination modes shown in FIG. 13. The illumination modes which may be obtained include those which could be obtained using the array of primary reflective elements moveable between first and second orientations. This is advantageous for reasons described below.

At the third point on the upgrade path, there are additional illumination locations which were not illuminated at the second point on the upgrade path. For this reason, there may be additional secondary reflective elements.

In one example, 1050 secondary reflective elements are used at the third point in the upgrade path. This corresponds with 350 primary reflective elements.

It is common for a user of a lithographic apparatus to use the lithographic apparatus to form a variety of different patterns (e.g., each pattern being provided on a different mask). A user may determine the best illumination mode to use when imaging a particular pattern. Once this determination has been made, the user will continue to use that illumination mode whenever imaging that pattern. The user will not change any properties of the illumination mode. If the user were to change properties of the illumination mode, then this would change the manner in which the pattern were to be projected onto the substrate. Changing a property of the illumination mode could for example change the thickness of pattern features formed on the substrate. This is undesirable, since the user will want the pattern to always be formed with the same pattern feature thickness.

A user may wish to upgrade a lithographic apparatus by for example changing from an array of primary reflective elements which are moveable between two orientations, to an array of primary reflective elements are movable to three orientations (i.e. from the second point on the upgrade path to the third point on the upgrade path). This upgrade may allow the user for example to project new patterns having features with a smaller critical dimension, by providing illumination modes which have wider diameters. In addition to projecting new patterns however, the user is likely to also want to use the lithographic apparatus to project patterns which were previously projected (i.e. prior to the upgrade). The upgraded lithographic apparatus should therefore be capable of providing an illumination mode which is the same as the illumination mode that was used prior to the upgrade. The embodiments of the invention provide this capability. This allows the user to project new patterns using the upgraded array of primary reflective elements, but also to project any patterns which were projected prior to the upgrade.

Although the above example relates to upgrading from the second point on the upgrade path to the third point on the upgrade path, the same applies when upgrading from the first point on the upgrade path to the second point on the upgrade path. For example, the array of primary reflective elements which are movable to three orientations may be used to form the illumination mode that was provided by the array of fixed primary reflective elements.

Appropriate selection of the inner and outer radial extent of the illumination modes allows the lithographic apparatus to be upgraded without losing the ability to provide illumination modes which were achievable prior to the upgrade.

The inner radial extent σ₂ and outer radial extent σ₃ of the intermediate location group are selected such that the same amount of radiation is provided to each illumination location group. If the radiation has a uniform energy density in the pupil plane, then each illumination location group should have the same area. This may be expressed as follows:

$$\begin{matrix}π ( {σ}_{2}^{2} - {σ}_{in}^{2} ) = π ( {σ}_{3}^{2} - {σ}_{2}^{2} ) \\ = π ( {σ}_{out}^{2} - {σ}_{3}^{2} ) \\ = \frac{π}{3} ( {σ}_{out}^{2} - {σ}_{in}^{2} ) \\ = \frac{π}{2} ( {σ}_{3}^{2} - {σ}_{in}^{2} )\end{matrix} \qquad ( 1 )$$

To recap the terms in Equation (1): the inner illumination location group has an inner radial extent σᵢₙₙₑᵣ and an outer radial extent σ₂; the intermediate illumination location group has an inner radial extent σ₂ and an outer radial extent σ₃; and the outer illumination location group has an inner radial extent σ₃ and an outer radial extent σₒᵤₜₑᵣ.

Equation (1) may be rearranged to provide a calculation of the inner radial extent σ₂ and outer radial extent σ₃ of the intermediate location group:

$${σ}_{2} = \sqrt{\frac{1}{3} {σ}_{out}^{2} + \frac{2}{3} {σ}_{in}^{2}} \\ {σ}_{3} = \sqrt{\frac{2}{3} {σ}_{out}^{2} + \frac{1}{3} {σ}_{in}^{2}} \qquad ( 2 )$$

In the illustrated embodiments, the inner radial extent of the inner illumination location group σᵢₙₙₑᵣ is zero, and the outer radial extent of the outer illumination location group σₒᵤₜₑᵣ is normalized to 1. In this situation, Equation (2) provides the following values: σ₂=\sqrt{⅓}≈0.577 and σ₃=\sqrt{⅔}≈0.816.

As mentioned above, it is not necessary for the inner radial extent of the inner illumination location group σᵢₙₙₑᵣ to be zero. Having a non-zero value will lead to different values for the inner radial extent σ₂ and outer radial extent σ₃ of the intermediate location group.

It is possible to express σ₂ and σₒᵤₜ in terms of σᵢₙ and σ₃:

$${σ}_{2} = \sqrt{( {σ}_{in}^{2} + {σ}_{3}^{2} ) / 2} \\ {σ}_{out} = \sqrt{( - {σ}_{in}^{2} + 3 {σ}_{3}^{2} ) / 2} \qquad ( 3 )$$

Although described embodiments of the invention have referred to 16 primary reflective elements or 48 primary reflective elements, any suitable number of primary reflective elements may be used. Similarly, any suitable number of secondary reflective elements may be used. At the second point on the upgrade path, there are twice as many secondary reflective elements as primary reflective elements. At the third point on the upgrade path, there are three times as many secondary reflective elements as primary reflective elements.

The above description has referred to a reflective illumination system (e.g. comprising part of an EUV lithographic apparatus). However, an embodiment of the invention may be provided in an illumination system which comprises refractive elements. An embodiment of the invention may for example be provided in a DUV lithographic apparatus. Refractive optical components may be provided in the illumination system pupil plane instead of or in addition to reflective optical components.

While specific embodiments of the invention have been described above, it will be appreciated that the invention may be practiced otherwise than as described. The description is not intended to limit the invention.

The features described herein are applicable to all aspects of the invention and may be used in any combination.

1. An illumination system having a plurality of reflective elements, the reflective elements being movable between different orientations which direct radiation towards different locations in a pupil plane, thereby forming different illumination modes;
each reflective element being moveable to a first orientation in which it directs radiation to a location in an inner illumination location group, to a second orientation in which it directs radiation to a location in an intermediate illumination location group, and to a third orientation in which it directs radiation to a location in an outer illumination location group;
wherein the reflective elements are configured to be oriented such that they can direct equal amounts of radiation towards the inner, intermediate and outer illumination location groups, and are configured to be oriented such that they can direct substantially no radiation into the outer illumination location group and direct substantially equal amounts of radiation towards the inner and intermediate illumination location groups.

2. The illumination system of claim 1, wherein the inner illumination location group, the intermediate illumination location group, and the outer illumination location group all have the same surface area.

3. The illumination system of claim 1, wherein the inner illumination location group has an inner radial extent σᵢₙ and an outer radial extent σ₂, the intermediate illumination location group has an inner radial extent σ₂ and an outer radial extent σ₃, and the outer illumination location group has an inner radial extent σ₃ and an outer radial extent σₒᵤₜ;
wherein the radial extents of the illumination location groups have the following relationships
0≦σᵢₙ<σ₂<σ₃<σₒᵤₜ≦1
and
$${σ}_{2} = \sqrt{\frac{1}{3} {σ}_{out}^{2} + \frac{2}{3} {σ}_{in}^{2}}$$
$${σ}_{3} = \sqrt{\frac{2}{3} {σ}_{out}^{2} + \frac{1}{3} {σ}_{in}^{2}} .$$

4. The illumination system of claim 3, wherein the radial extents are circular.

5. The illumination system of claim 4, wherein the inner, intermediate and outer illumination location groups are annular.

6. The illumination system of claim 3, wherein the inner radial extent σᵢₙ of the inner illumination location group is zero, and the other radial extents are circular, and wherein the inner illumination location group is a disk, and the intermediate and outer illumination location groups are annular.

7. A lithographic apparatus comprising:
an illumination system having a plurality of reflective elements the reflective elements being movable between different orientations which direct radiation towards different locations in a pupil plane, thereby forming different illumination modes;
each reflective element being moveable to a first orientation in which it directs radiation to a location in an inner illumination location group, to a second orientation in which it directs radiation to a location in an intermediate illumination location group, and to a third orientation in which it directs radiation to a location in an outer illumination location group;
wherein the reflective elements are configured to be oriented such that they can direct equal amounts of radiation towards the inner, intermediate and outer illumination location groups, and are configured to be oriented such that they can direct substantially no radiation into the outer illumination location group and direct substantially equal amounts of radiation towards the inner and intermediate illumination location groups.

8. A method of switching between illumination modes, the method comprising orienting a plurality of reflective elements such that they direct equal amounts of radiation towards inner, intermediate and outer illumination location groups in a pupil plane, and then subsequently orienting the plurality of reflective elements such that they direct substantially no radiation towards the outer illumination location group and direct substantially equal amounts of radiation towards the inner and intermediate illumination location groups.

9. The method of claim 8, wherein the inner illumination location group, the intermediate illumination location group, and the outer illumination location group all have the same surface area.

10. The method of claim 8, wherein the inner illumination location group has an inner radial extent σᵢₙ and an outer radial extent σ₂, the intermediate illumination location group has an inner radial extent σ₂ and an outer radial extent σ₃, and the outer illumination location group has an inner radial extent σ₃ and an outer radial extent σₒᵤₜ;
wherein the radial extents of the illumination location groups have the following relationships
0<σᵢₙ<σ₂<σ₃<σₒᵤₜ≦1
and
$${σ}_{2} = \sqrt{\frac{1}{3} {σ}_{out}^{2} + \frac{2}{3} {σ}_{in}^{2}}$$
$${σ}_{3} = \sqrt{\frac{2}{3} {σ}_{out}^{2} + \frac{1}{3} {σ}_{in}^{2}} .$$

11. The method of claim 10, wherein the radial extents are circular.

12. The method of claim 11, wherein the inner, intermediate and outer illumination location groups are annular.

13. The method of claim 10, wherein the inner radial extent σᵢₙ of the inner illumination location group is zero, and the other radial extents are circular, and wherein the inner illumination location group is a disk, and the intermediate and outer illumination location groups are annular.
